(19) United States
(12) Patent Application Publication
(10) Pub. No.: US 2023/0329466 A1
(43) Pub. Date: Oct. 19, 2023

(54) PAPER DRINKING STRAW, BEVERAGE CONTAINER, AND METHOD FOR PRODUCING THE PAPER DRINKING STRAW

(71) Applicant: CAPRI SUN AG, Zug (CH)

(72) Inventors: Andreas Korbmann, Eppelheim (DE); Beatus Schehl, Eppelheim (DE); Erhard Schwartz, Wiesloch (DE)

(21) Appl. No.: 17/782,461

(22) PCT Filed: Jul. 7, 2021
(86) PCT No.: PCT/EP2021/068878

§ 371 Date: Jun. 3, 2022

(30) Foreign Application Priority Data
Jul. 20, 2020 (EP) 20186740.5

(51) Int. Cl. A47G 21/18; B31D 5/00

(52) U.S. Cl. CPC A47G 21/18; B31D 5/0095

(57) ABSTRACT

The invention refers to a paper drinking straw (17, 23, 29, 35, 49, 62, 69, 77, 99, 105, 114, 121) comprising a paper tube (1, 9, 18, 24, 30, 36, 63, 70, 78, 99, 105, 114, 121) with a first end (2, 10, 21, 27, 33, 39, 65, 72, 80, 100, 106, 115, 122) and a second end (3, 11, 22, 28, 34, 40, 67, 75, 82, 101, 107, 116, 123). At least one impregnated region (20, 26, 32, 38, 66, 73, 103, 109, 110, 111, 118, 119, 125) of the paper tube is impregnated with an impregnation agent, and at least one region (104, 112, 113, 120, 126) is not impregnated with the impregnation agent. A beverage container for receiving liquid product comprises the paper drinking straw and a penetration opening for introducing it. A method for producing the paper drinking straw comprises providing a raw paper tube; cutting through the raw paper tube, thereby producing the paper tube with the first and second end; then impregnating the at least one impregnated region with the impregnation agent and not impregnating the at least one region with the impregnation agent.

The present invention refers to a paper drinking straw according to the preamble of claim 1, a beverage container according to claim 17, and a method for producing a paper drinking straw according to claim 19.

### PRIOR ART

GB 2579107 A discloses a paper drinking straw with a first and a second paper layer each comprising an inner and an outer surface. A paper core layer comprises a first and a second surface. The inner surface of the first paper layer is bonded to the first surface of the paper core layer, and the inner surface of the second paper layer is bonded to the second surface of the paper core layer. At least the outer surfaces of the first and second paper layer are coated with a water-resistant barrier coating that may comprise a styrene free acrylic based coating, a styrene-based coating, a polymer dispersion coating, modified starch, vegetable oil, or a natural wax. The coating may be applied using a water-based dispersion coating method.

EP 3 581 071 A1 discloses a coated paper straw being rolled into a tube from a sheet. The sheet is a coated paper strip comprising a coated paper with one or two waterproof coating layers. The paper straw has an interface edge that is joined by overlapping portions of two sides of the coated paper strip along the longitudinal direction. The coating layer is at least located on the exterior side of the paper straw, and may be made of a biodegradable coated resin.

US 2019/0343312 A1 discloses a straw with an upper part comprising a hollow plastic tube with a movable, length adaptable section, wherein the plastic may be biodegradable, and with a lower tube shape part made of biodegradable paper. The bottom end of the upper part is coupled to the top end of the lower part. The top end of the lower part may comprise a necked down portion in which the diameter is reduced that may be inserted into the bottom end of the upper part.

It is known that for producing paper drinking straws, several paper layers that may be coated with adhesive are helically or horizontally wound and finally stuck together.

For example, WO 2020/099360 A1 discloses a system and a method for producing lengths of tube, wherein strips are supplied with a strip supplying device to a winding device and are helically wound around a mandrel to form a base tube moving away from the mandrel at a tube speed. A selection of at least one of the strips is placed with a contact side thereof in direct contact with the mandrel during the winding, wherein the at least one strip of the selection is moved along a lubrication device to apply a layer of lubrication material on the contact side of the at least one strip before the at least one strip is wound around the mandrel. The base tube may be cut at a predetermined length with a cutting device while the base tube is moving in a tube direction at the tube speed.

In order to enable the penetration of a paper drinking straw into a penetration opening of a beverage container one end of the paper drinking straw is provided with a slant for forming a bevelled tip. However, the bevelled tip reduces the stability of the paper drinking straw in the area of the tip. Thus, by a light touch or by applying a pressure, the tip may fold over or may kink. Consequently, penetrating the paper drinking straw with the tip into the penetration opening of a beverage container may be hindered or may even be impossible.

### OBJECT

The invention thus has the object to provide a paper drinking straw and a beverage container with the paper drinking straw, the paper drinking straw being ecologically safe and providing satisfactory stability.

### Solution

This object is solved by the paper drinking straw of claim 1 and the beverage container of claim 17, and the method for producing a paper drinking straw of claim 19. Additional embodiments and improvements are disclosed in the dependent claims.

The paper drinking straw for a beverage container comprises a paper tube with a first end and a second end. At least one impregnated region of the paper tube is impregnated with an impregnation agent and at least one region of the paper tube is not impregnated with the impregnation agent.

The impregnation of the at least one impregnated region of the paper tube may increase the stability of this region. Thus, also the stability of the paper drinking straw as a whole may be increased.

The at least one region not being impregnated with the impregnation agent also is not impregnated with any other king of impregnation agent. This may apply for all the various embodiments and examples of paper drinking straws mentioned throughout this application.

The impregnation agent may penetrate into pores and spaces between fibres of the paper. Additionally, the impregnation agent may penetrate at least partially into fibres of the paper.

The at least one impregnated region may comprise a first impregnated region starting form a second end of the paper tube and extending towards the first end of the paper tube and being impregnated with the impregnation agent. Exemplarily the first impregnated region may extend for less than 80% or 90% of a total length of the paper tube.

The word “first” is being used to distinguish the different regions mentioned. It has no further limiting meaning. The first impregnated region may be the only impregnated region of the paper tube, or the paper tube may comprise one or more additional impregnated regions; as long as at least one region of the paper tube is not impregnated with the impregnation agent.

The at least one impregnated region may comprise a second impregnated region starting at a distance from a second end of the paper tube and extending as an annular ring towards the first end of the paper tube and being impregnated with the impregnation agent. Exemplarily the annular ring may have a width of 10% to 25% of a total length of the paper tube. Exemplarily the distance may be 20% to 50% of the total length of the paper tube.

The word “second” is being used to distinguish the different regions mentioned. It has no further limiting meaning. The second impregnated region may be the only impregnated region of the paper tube, or the paper tube may comprise one or more additional impregnated regions; as long as at least one region of the paper tube is not impregnated with the impregnation agent.

The at least one impregnated region may comprise a third impregnated region starting form the first end of the paper tube and extending towards the second end of the paper tube and being impregnated with the impregnation agent, wherein exemplarily the third impregnated region extends for less than 80% or 90% of a total length of the paper tube.

The word “third” is being used to distinguish the different regions mentioned. It has no further limiting meaning. The third impregnated region may be the only impregnated region of the paper tube, or the paper tube may comprise one or more additional impregnated regions; as long as at least one region of the paper tube is not impregnated with the impregnation agent.

Starting from the second end of the paper tube 70%, 80%, 90%, or 100% of a total length of the paper tube may not be impregnated with the impregnation agent, wherein when starting from the second end of the paper tube 100% of the total length of the paper tube are not impregnated with the impregnation agent a cutting edge at the first end of the paper tube is impregnated with the impregnation agent. When 100% of the total length of the paper tube are not impregnated, e.g., the cutting edge of the bevelled tip may be impregnated.

The impregnation agent may comprise one or more of silicate, polymer, resin (artificial or natural), wax (artificial or natural), adhesive, latex, also casein glue or shellac.

The impregnation agent may comprise sodium silicate. For example, sodium silicate may be used that comprises an aqueous solution of glasslike and water soluble sodium silicate that has solidified from a melting. Drying of the aqueous solution of sodium silicate starts with evaporation of the water and leads to creation of water-insoluble silica, thus leading to silification. The silification is irreversible.

The sodium silicate may comprise SiO₂3.3/3.5Na₂O, e.g., with 27.5% to 28.5% SiO₂ and 8.1% to 8.5% Na₂O.

The paper tube may comprise a winded paper layer, wherein the impregnation agent may only have been applied to an exposed surface of the paper tube. The exposed surface may comprise an outer surface and/or an inner surface and/or a cutting edge of the paper tube.

The paper tube can comprise a paper layer of several layers of paper. The several layers of paper may be glued together. Cutting edges and interspaces may be sealed. Sealing may take place before impregnating the bevelled tip. The width and the thickness, e.g., in grams per square metre, may be different for the several layers.

The first end of the paper tube can comprise a straight end and the second end of the paper tube can comprise a straight end. A straight end may mean that a cutting edge at the first/second end may extend vertically to the longitudinal axis of the paper tube. Some deviation of ±1 degree may also be considered a straight end.

Alternatively, the first end of the paper tube can comprise a bevelled tip and the second end of the paper tube can comprise a straight end. The bevelled tip may be produced by an oblique cut of a paper tube. A cutting edge at the first end may extend with an angle to the longitudinal axis of the paper tube between 20° to 75°. For example, the angle may lay in a region between 30°±5° or in a region between 45°±5°. For measuring and/or determining the angle, a plane in that the cutting edge lies may be defined and the angle extending between this plane and the longitudinal axis of the paper tube may be measured and/or determined.

The bevelled tip can be at least partially impregnated with an impregnation agent. The impregnation of at least part of the bevelled tip improves its hardness and stability such that folding over or kinking of the bevelled tip can be prevented and a reliable penetration of the bevelled tip into the beverage container is possible.

Moreover, capillary action at the cutting edge of the bevelled tip can be reduced as penetration of the liquid provided in the beverage container may be prevented or strongly reduced.

The cutting edge of the bevelled tip can be impregnated with the impregnation agent. Starting from the cutting edge, a depth of at least 0.5 mm, 1 mm, or 1.5 mm can be impregnated with the impregnation agent. When the depth of at least 0.5 mm, 1 mm, or 1.5 mm is impregnated with the impregnation agent, pores, space, and the like between the fibres of the paper of the paper drinking straw and/or the fibres of the paper of the paper drinking straw may comprise the impregnation agent.

A cutting edge of the bevelled tip being impregnated with the impregnation agent can be achieved when during a production process of the paper drinking straw, the bevelled tip is produced first and then, afterwards, the impregnation agent is provided to the bevelled tip. Like that, the bevelled tip can be at least partially impregnated with impregnation agent and additionally the cutting edge of the bevelled tip can be impregnated with the impregnation agent.

The paper may comprise at least one of: wood fibres, bamboo fibres, bagasse fibres, seaweed fibres, fibres of banana plant, fibres of Abaca plant, synthetic fibres, polymer-based fibres, plastic fibres.

For producing the paper drinking straw, first the paper tube may be produced and the bevelled tip may be provided. Only after that, the bevelled tip is at least partly impregnated. Thus, the at least one paper layer, or at least some part of the at least one paper layer for producing the paper tube does not have to be impregnated and/or has to comprise impregnation agent before the paper tube is produced and before the bevelled tip is provided.

At least an are impregnated with and/or an outer surface of the paper tube and/or a cutting edge of the bevelled tip may be impregnated with the impregnation agent. Alternatively or additionally, the cutting edge of the bevelled tip may be impregnated partially or completely.

Regions aside of the bevelled tip may not impregnated with the impregnation agent. Thus, the required amount of impregnation agent may be reduced. An impregnation of the total paper drinking straw may not be required as long as the bevelled tip is at least partially impregnated.

The bevelled tip may be at least partially impregnated with an impregnation agent only after providing the bevelled tip. Impregnating the bevelled tip with the impregnation agent only after providing the bevelled tip may result in a penetration of the impregnation agent into pores and spaces between fibres of the paper also with an origin at the cutting edge of the bevelled tip. Additionally, the impregnation agent may penetrate at least partially into fibres of the paper also with an origin at the cutting edge of the bevelled tip.

For all embodiments above and below the impregnation agent can be provided on the paper drinking straw by spraying it onto the paper drinking straw or by dipping the paper drinking straw into a liquid impregnation agent. After dipping it into the impregnation agent, air or any other gas may be used to blow of superfluous impregnation agent. The spraying can be performed by means of a nozzle that ejects the impregnation agent onto the region of the paper drinking straw that is to be impregnated. After application of the impregnation agent by spraying or by dipping the impregnation agent may be caused to solidify by hardening it (e.g. in case of a resin) or by drying it (e.g. in case of a silicate).

Alternatively, the impregnation agent can be applied by bringing the paper drinking straw in contact with a material that is soaked with the impregnation agent such as a sponge or tissue or felt to thereby provide the agent to the paper drinking straw.

Also, the impregnation agent can be applied to a cutting knife such that the agent is transferred to the cutting edge at the same time as the bevelled edge is prepared.

The beverage container for receiving liquid product comprises a penetration opening for introducing a paper drinking straw as described above or below, and the paper drinking straw. The paper drinking straw may be provided in a hygienic packaging. The hygienic packaging may be at least partially attached to the beverage container in a stable manner; it may be stuck to it and/or it may be removable from it. The paper drinking straw can be removed from the hygienic packing, wherein the hygienic packing may be still attached to the beverage container or may have been taken off the beverage container.

The beverage container can be designed as a beverage carton, as a foil bag or as a stand-up pouch.

The method for producing a paper drinking straw according to one of the embodiments and/or examples described above or below comprises:
providing a raw paper tube;
cutting through the raw paper tube, thereby producing the paper tube with the first end and the second end; and
then impregnating the at least one impregnated region with the impregnation agent and not impregnating the at least one region of the paper tube with the impregnation agent.

The impregnating the at least one impregnated region can comprise:
impregnating a first impregnated region starting form the second end of the paper tube and extending towards the first end of the paper tube with the impregnation agent, wherein exemplarily the first impregnated region extends for less than 80% or 90% of a total length of the paper tube, and/or
impregnating a second impregnated region starting at a distance from a second end of the paper tube and extending as an annular ring towards the first end of the paper tube with the impregnation agent, wherein exemplarily the annular ring has a width of 10% to 25% of a total length of the paper tube, wherein exemplarily the distance is 20% to 50% of the total length of the paper tube, and/or
impregnating a third impregnated region starting form the first end of the paper tube and extending towards the second end of the paper tube with the impregnation agent, wherein exemplarily the third impregnated region extends for less than 80% or 90% of a total length of the paper tube.

The impregnating the at least one impregnated region can comprise further or additionally:
impregnating a cutting edge at the first end of the paper tube with the impregnation agent.

The cutting through can be a straight cutting resulting that the first end comprises a straight first end.

Alternatively, the cutting through being an oblique cutting resulting that the first end comprises a bevelled tip.

The method can further comprise at least partially impregnating the bevelled tip with the impregnation agent.

The method can further comprise impregnating at least an inner surface and/or an outer surface and/or a cutting edge of the bevelled tip with the impregnation agent.

The method can further comprise not impregnating regions aside of the bevelled tip with the impregnation agent.

The method can further comprise impregnating the bevelled tip at least partially with the impregnation agent only after providing the bevelled tip.

The cutting can be done with a cutting knife, wherein the impregnation agent can be applied to the cutting knife and wherein the impregnation agent can be transferred to the cutting edge during the cutting of the raw paper straw.

The method can further comprise solidifying the impregnation agent by hardening or drying, wherein exemplarily solidifying the impregnation agent of the at least partially impregnated bevelled tip and/or solidifying the impregnation agent of the first impregnated region and/or solidifying the impregnation agent of the second region and/or solidifying the impregnation agent of the cutting edge by hardening or drying can be performed at the same time or at at least two different times.

### BRIEF DESCRIPTION OF THE FIGURES

The attached figures illustrate exemplified for better understanding and for visualisation aspects and embodiments of the invention.

FIGS. 1A, 1B illustrate inclined views from below on different states of a paper tube with horizontal winding,

FIG. 1C illustrates a side view on the paper tube of FIG. 1B,

FIGS. 2A, 2B illustrate inclined views from below on different states of a paper tube with helically winding,

FIG. 2C illustrates a side view on the paper tube of FIG. 2B,

FIGS. 3A, 3B, 3C, 3D, 3E, 3F, 3G illustrate schematically different embodiments of paper drinking straws where different parts are impregnated with an impregnating agent,

FIG. 4 illustrates a cross section of a paper drinking straw comprising three paper layers,

FIG. 5A illustrates an inclined view from the top on a beverage carton with inserted paper drinking straw of the second embodiment,

FIG. 5B illustrates an inclined view from the top on a foil bag with an inserted drinking straw of the second embodiment,

FIG. 5C illustrates an inclined view from the top on the beverage carton with inserted paper drinking straw of the fifth embodiment,

FIG. 5D illustrates an inclined view from the top on the foil bag with an inserted drinking straw of the sixth embodiment,

FIG. 5E illustrates an inclined view from the top on the beverage carton with inserted paper drinking straw of the seventh embodiment,

FIG. 6 illustrates an inclined view from below on a paper drinking straw before impregnating comprising a paper tube with horizontal winding, and two straight ends,

FIG. 7 illustrates an inclined view from below on a paper drinking straw before impregnating comprising a paper tube with helically winding, and two straight ends,

FIGS. 8A, 8B, 8C, 8D illustrate schematically different embodiments of paper drinking straws with two straight ends where different parts are impregnated with an impregnating agent,

FIG. 9A illustrates an inclined view from above on the beverage carton with the inserted paper drinking straw of FIG. 8C, and

FIG. 9B illustrates an inclined view from above on the foil bag with the inserted paper drinking straw of FIG. 8B.

### DETAILED DESCRIPTION OF THE FIGURES

The following figures disclose embodiments being related to paper drinking straws comprising one straight end and a bevelled tip at the other end.

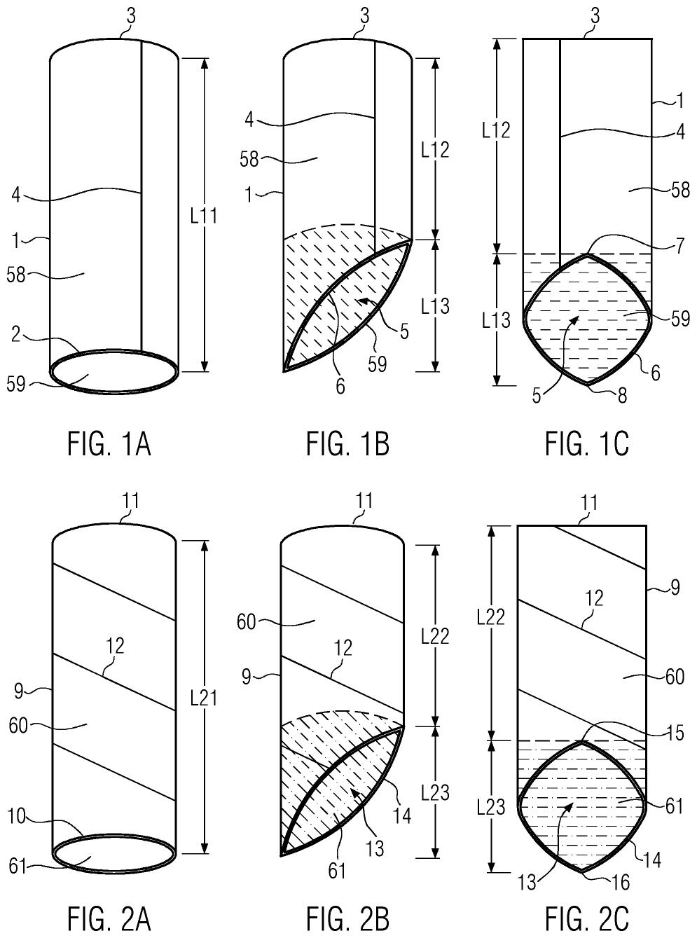

FIG. 1A illustrates an inclined view from below of a paper tube 1 with a total length L11 that might have been cut from an endless paper tube, wherein the endless paper tube has been produced by horizontal winding of at least one paper layer. The paper tube 1 comprises a first end 2 and a second end 3. Moreover, a connection edge 4 is depicted, where edges of the at least one paper layer firmly adjoin and that extends in a longitudinal direction. The paper tube 1, and thus the paper drinking straw produced from it, comprises an inner surface 59 pointing to the interior of the paper tube 1, and an outer surface 58 pointing to the exterior of the paper tube 1.

By applying a physical oblique cut that starts at a starting point in a distance L13 from the first end 2 of the paper tube 1, a bevelled tip 5 with a cutting edge 6 is provided (see FIG. 1B). The paper tube of FIG. 1B may also be obtained by applying an oblique cut to a paper tube of the length L12 plus L11, which cuts the tube into two equal parts, one of which is shown in FIG. 1B. The remaining length L12 of the paper tube 1 above the oblique cut amounts to the difference of the distance L13 from the total length L11 of the paper tube 1. The part of the paper tube 1 that represents the bevelled tip 5 is indicated by the dashed region. The dashed region comprises the part of the paper tube 1 that extends between a plane, the plane being perpendicular to a longitudinal axis of the paper tube 1 and going through the starting point of the oblique cut, and the first end 2 of the paper tube 1.

FIG. 1C illustrates a side view on the paper tube 1 of FIG. 1B. An upper end 7 of the bevelled tip 5 and a lower end 8 of the bevelled tip 5 are illustrated. The upper end 7 may correspond to the starting point of the physical oblique cut. The lower end 8 may be used for penetrating a penetration opening of a beverage container.

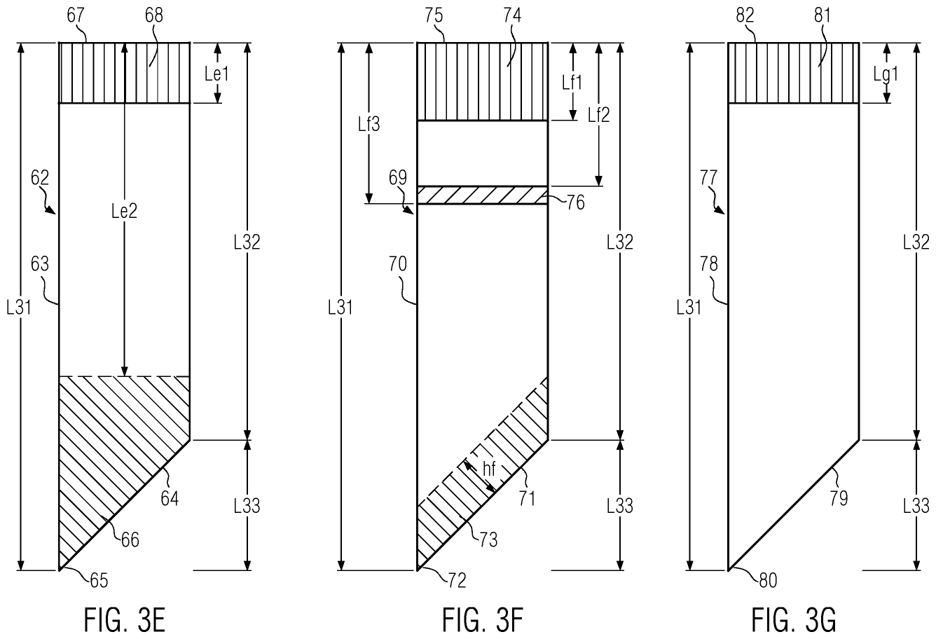

After providing the bevelled tip 5, the bevelled tip 5, a part of the bevelled tip 5, a part of the bevelled tip 5 and another part of the paper tube 1, or the bevelled tip 5 and another part of the paper tube 1 may be impregnated with an impregnation agent; see FIGS. 3A, 3B, 3C, 3D. It is also possible to only impregnate the cutting edge 6 of the bevelled tip 5, e.g., partially or completely. Thus, the at least one paper layer, or at least some part of the at least one paper layer for producing the paper tube 1 does not have to be impregnated and/or has to comprise impregnation agent before the paper tube 1 is produced and before the bevelled tip 5 is provided.

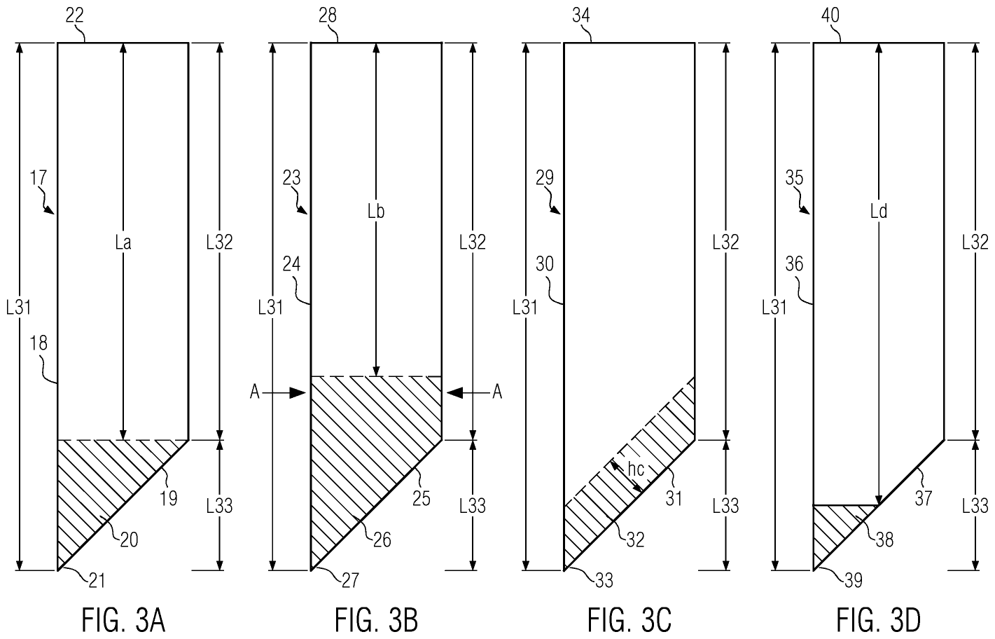

FIG. 2A illustrates an inclined view from below of a paper tube 9 with a total length L21 that might have been cut from an endless paper tube, wherein the endless paper tube has been produced by helically winding of at least one paper layer. The paper tube 9 comprises a first end 10 and a second end 11. Moreover, a connection edge 12 where edges of the at least one paper layer firmly adjoin and that extends helically is depicted. The paper tube 9, and thus the paper drinking straw produced from it, comprises an inner surface 61 pointing to the interior of the paper tube 9, and an outer surface 60 pointing to the exterior of the paper tube 9.

By applying a physical oblique cut that starts at a starting point in a distance L23 from the first end 10 of the paper tube 9, a bevelled tip 13 with a cutting edge 14 is provided. The remaining length L22 of the paper tube 9 above the oblique cut amounts to the difference of the distance L23 from the total length L21 of the paper tube 9. The part of the paper tube 9 that represents the bevelled tip 13 is indicated by the dashed-pointed region. The dashed-pointed region comprises the part of the paper tube 9 that extends between a plane, the plane being perpendicular to a longitudinal axis of the paper tube 9 and going through the starting point of the oblique cut, and the first end 10 of the paper tube 9. The paper tube 11 as shown in FIG. 2B may also be obtained by applying an oblique cut to a paper tube of the length L22 plus L21 producing two equal parts one of which is shown in FIG. 2B.

FIG. 2C illustrates a side view on the paper tube 9 of FIG. 2B. An upper end 15 of the bevelled tip 13 and a lower end 16 of the bevelled tip 13 are illustrated. The upper end 15 may correspond to the starting point of the physical oblique cut. The lower end 16 may be used for penetrating a penetration opening of a beverage container.

After providing the bevelled tip 13, the bevelled tip 13, a part of the bevelled tip 13, a part of the bevelled tip 13 and another part of the paper tube 9, or the bevelled tip 13 and another part of the paper tube 9 may be impregnated with an impregnation agent; see FIGS. 3A, 3B, 3C, 3D. It is also possible to only impregnate the cutting edge 14 of the bevelled tip 9. Thus, the at least one paper layer, or at least some part of the at least one paper layer for producing the paper tube 9 does not have to be impregnated and/or has to comprise impregnation agent before the paper tube 9 is produced and before the bevelled tip 13 is provided.

FIG. 3A illustrates a first embodiment of a paper drinking straw 17 that comprises a paper tube 18 with a bevelled tip 19 at a first end 21 of the paper tube 18; the paper tube 18 may be one of FIG. 1B/1C or of FIG. 2B/2C or another suitable paper tube. The paper tube 18 and thus the paper drinking straw 17 comprise a total length L31. The physical oblique cut for providing the bevelled tip 19 started at a distance L33 from the first end 21 of the paper tube 18. The length L32 of the paper tube 18 and thus of the paper drinking straw 17 above the oblique cut is the difference of the distance L33 from the total length L31 of the paper tube 18 and the paper drinking straw 17, respectively.

A region 20 in that the bevelled tip 19 has been impregnated with the impregnation agent is indicated by hatching. In the illustrated case, the impregnated region corresponds to the bevelled tip 19 and starts at a distance La from the second end 22 of the paper tube 18 and the paper drinking straw 17, respectively. The value of the distance La corresponds to the value of the length L32 above the oblique cut.

FIG. 3B illustrates a second embodiment of a paper drinking straw 23 comprising a paper tube 24 with a bevelled tip 25 at the first end 27 of the paper tube 24 that also may be one of FIG. 1B/1C or of FIG. 2B/2C or another suitable paper tube. The total length L31, the length L32 and the distance L33 correspond to those of the first embodiment as depicted in FIG. 3A.

Moreover, a region 26 in that the bevelled tip 25 has been impregnated with the impregnation agent is indicated by hatching. This region 26 starts at a distance Lb from the second end 28 of the paper tube 24. The value of the distance Lb is smaller than the value of the length L32 of the paper tube 24 and thus of the paper drinking straw 23 above the oblique cut. The impregnated region 26 thus comprises the bevelled tip 25 and another part of the paper tube 24.

FIG. 3C illustrates a third embodiment of a paper drinking straw 29 comprising a paper tube 30 with a bevelled tip 31 at a first end 33 of the paper tube 30 that also may be one of FIG. 1B/1C or of FIG. 2B/2C or another suitable paper tube. The total length L31, the length L32 and the distance L33 correspond to those of the first embodiment as depicted in FIG. 3A, and the second embodiment as depicted in FIG. 3B, respectively.

Moreover, a region 32 in that part of the bevelled tip 31 has been impregnated with impregnation agent is indicated by hatching. This region 32 extends in a distance hc parallel to the cutting edge of the bevelled tip 31. The region 32 may also be not parallel to the cutting edge but inclined to it.

FIG. 3D illustrates a fourth embodiment of a paper drinking straw 35 comprising a paper tube 36 with a bevelled tip 37 at the first end 39 of the paper tube 36 that also may be one of FIG. 1B/1C or of FIG. 2B/2C or another suitable paper tube. The total length L31, the length L32 and the distance L33 correspond to those of the first, second and third embodiments.

Moreover, a region 38 in that part of the bevelled tip 37 has been impregnated with the impregnation agent is indicated by hatching. This region 38 starts at a distance Ld from the second end 40 of the paper tube 36. The value of the distance Ld is bigger than the value of the length L32 of the paper tube 36 and thus of the paper drinking straw 35 above the oblique cut. The impregnated region 38 thus only comprises a part of the bevelled tip 37. In general, also only a part of the cutting edge may be impregnated.

FIG. 3E illustrates a fifth embodiment of a paper drinking straw 62 comprising a paper tube 63 with a bevelled tip 64 at the first end 65 of the paper tube 63. The paper tube 63 may be one of FIG. 1B/1C or of FIG. 2B/2C or another suitable paper tube. The total length L31, the length L32 and the distance L33 correspond to those of the first embodiment as depicted in FIG. 3A.

A region 66 in that the bevelled tip 64 has been impregnated with the impregnation agent is indicated by oblique hatching. This impregnated region 66 starts at a distance Le2 from the second end 67 of the paper tube 63. The value of the distance Le2 is smaller than the value of the length L32 of the paper tube 63. The impregnated region 66 thus comprises the bevelled tip 64 and another part of the paper tube 63.

Moreover, a first impregnated region 68 starting from the second end 67 of the paper tube 63 and extending towards the first end 65 of the paper tube 63 for a length Le1 is impregnated with the impregnation agent.

FIG. 3F illustrates a sixth embodiment of a paper drinking straw 69 comprising a paper tube 70 with a bevelled tip 71 at a first end 72 of the paper tube 70. Also here, the paper tube 70 may be one of FIG. 1B/1C or of FIG. 2B/2C or another suitable paper tube. The total length L31, the length L32 and the distance L33 correspond to those of the first embodiment as depicted in FIG. 3A.

A region 73 in that part of the bevelled tip 71 has been impregnated with impregnation agent is indicated by oblique hatching. This region 73 extends in a distance hf parallel to the cutting edge of the bevelled tip 71. The region 73 may also be not parallel to the cutting edge but be inclined to it (not shown).

Moreover, a first impregnated region 74 starting from the second end 75 of the paper tube 70 and extending towards the first end 72 of the paper tube 70 for a length Lf1 is impregnated with the impregnation agent. Additionally, a second impregnated region 76 starting at a distance Lf2 from the second end 75 of the paper tube 70 and extending as an annular ring towards the first end 72 of the paper tube 70 is impregnated with the impregnation agent. The annular ring extends between a distance Lf2 and a distance Lf3 form the second end 75 of the paper tube 70.

FIG. 3G illustrates a seventh embodiment of a paper drinking straw 77 comprising a paper tube 78 with a bevelled tip 79 at the first end 80 of the paper tube 78 that also may be one of FIG. 1B/1C or of FIG. 2B/2C or another suitable paper tube. The total length L31, the length L32 and the distance L33 correspond to those of the first embodiment as depicted in FIG. 3A.

A first impregnated region 81 starting from the second end 82 of the paper tube 78 and extending towards the first end 80 of the paper tube 78 for a length Lg1 is impregnated with the impregnation agent.

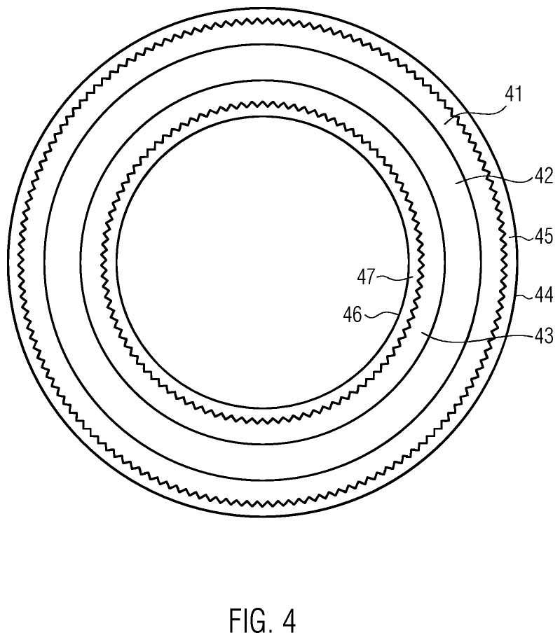

FIG. 4 illustrates a cross section of a paper drinking straw comprising three paper layers, e.g., a cross section along A-A as shown in FIG. 3B. A first paper layer 41 represents the outer layer, a second paper layer 42 the core paper layer, and a third paper layer 43 the inner layer. The outer surface 44 of the first paper layer 41 has been impregnated with impregnation agent and the impregnation agent also has penetrated partly into pores and spaces between fibres of the paper; this penetration region has been indicated with the reference sign 45.

The inner surface 46 of the third paper layer 43 also has been impregnated with impregnation agent and the impregnation agent has penetrated partly into pores and spaces between fibres of the paper; this penetration region has been indicated with the reference sign 47.

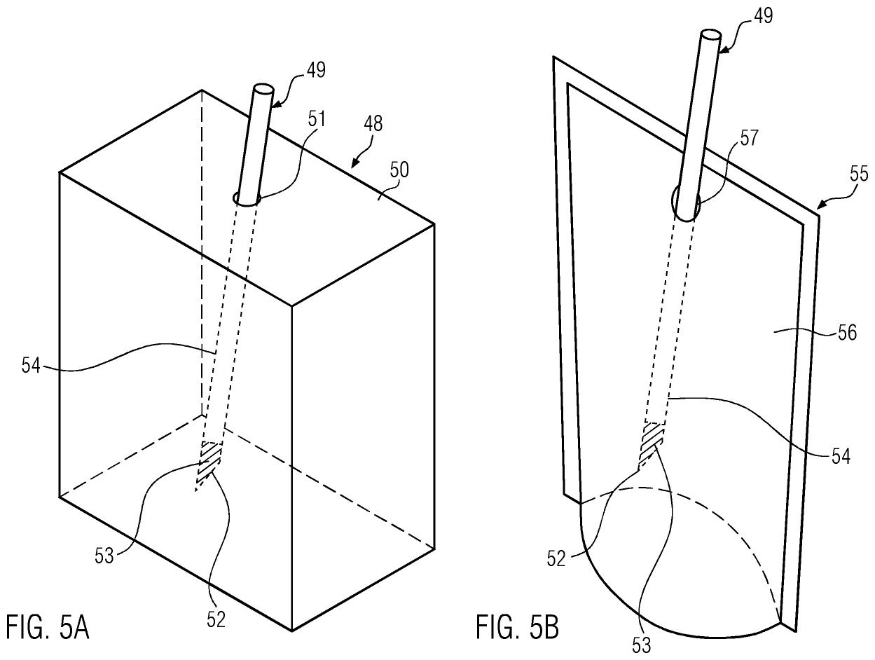

FIG. 5A illustrates an inclined view from above on a beverage container 48 with an inserted paper drinking straw 49 of the second embodiment. On the top side 50 of the beverage container 48 a penetration opening 51 is provided that is closed with a foil or the like before the bevelled tip 52 of the paper drinking straw 49 penetrates the penetration opening 51. A region 53 of the bevelled tip 52 and part of the paper tube 54 is impregnated with an impregnation agent.

FIG. 5B illustrates an inclined view from above of a foil bag 55 with an inserted paper drinking straw 49 of the second embodiment. On one bag side 56 of the foil bag 55 a penetration opening 57 is provided that is closed with a foil or the like before the bevelled tip 52 of the paper drinking straw 49 penetrates the penetration opening 57. The paper drinking straw 49 corresponds to the one of FIG. 5A.

FIG. 5C illustrates an inclined view from the top on the beverage container 48 with an inserted paper drinking straw 62 of the fifth embodiment. On the top side 50 of the beverage container 48 a penetration opening 51 is provided that is closed with a foil or the like before the bevelled tip 64 of the paper drinking straw 62 penetrates the penetration opening 51. The region 66 of the bevelled tip 64 and part of the paper tube 63 are impregnated with the impregnation agent. Additionally, the first region 68 extending from the second end 67 of the paper tube 63 in direction to the first end 65 is impregnated with the impregnation agent.

FIG. 5D illustrates an inclined view from the top on the foil bag 55 with an inserted paper drinking straw 69 of the sixth embodiment. On one bag side 56 of the foil bag 55 a penetration opening 57 is provided that is closed with a foil or the like before the bevelled tip 71 of the paper drinking straw 69 penetrates the penetration opening 57. The region 73 of the bevelled tip 71 and part of the paper tube 70 are impregnated with an impregnation agent. Additionally, the first region 74 extending from the second end 75 of the paper tube 70 in direction to the first end 72 is impregnated with the impregnation agent. Moreover, the second region 76 being an annular ring extending at some distance from the second end 75 in direction to the first end 72 is impregnated with the impregnation agent.

FIG. 5E illustrates an inclined view from the top on the beverage carton 48 with inserted paper drinking straw 77 of the seventh embodiment. On the top side 50 of the beverage container 48 the penetration opening 51 is provided that is closed with a foil or the like before the bevelled tip 79 of the paper drinking straw 77 penetrates the penetration opening 51. The first region 81 extending from the second end 82 of the paper tube 78 in direction to the first end 80 is impregnated with the impregnation agent. Other parts of the paper tube 78 are not impregnated with the impregnation agent.

The following figures disclose embodiments being related to paper drinking straws comprising two straight end.

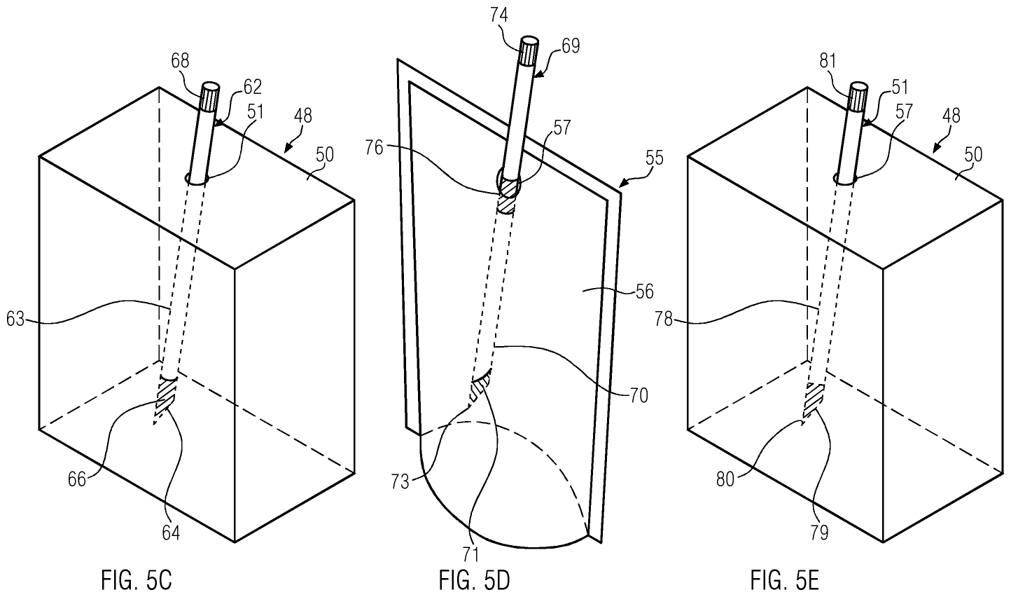

FIG. 6 illustrates an inclined view from below on a paper drinking straw 83 before impregnating comprising a paper tube 87 with horizontal winding, and two straight ends 84, 85, also called first end 84 and second end 85. The paper drinking straw 83 might have been cut from an endless paper tube, wherein the endless paper tube has been produced by horizontal winding of at least one paper layer. The cutting edge 86 of the first end 84 is visible in FIG. 6. The second end 85 also comprises a cutting edge that is not visible in FIG. 6. The paper tube 87 of the paper drinking straw 83 comprises a connection edge 86, where edges of the at least one paper layer firmly adjoin and that extends in a longitudinal direction. The paper tube 87, and thus the paper drinking straw 83 comprise an inner surface 89 pointing to the interior of the paper tube 87/paper drinking straw 83, and an outer surface 90 pointing to the exterior of the paper tube 87/paper drinking straw 83.

For the depicted paper drinking straw, at least one impregnated region of the paper tube 87 may be impregnated with an impregnation agent and at least one region of the paper tube 87 may not be impregnated with the impregnation agent.

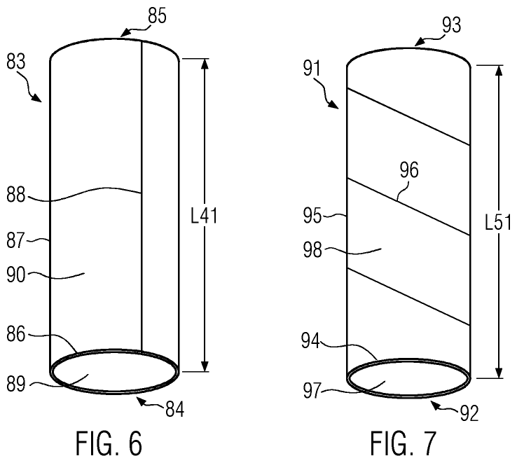

FIG. 7 illustrates an inclined view from below on a paper drinking straw 91 before impregnating comprising a paper tube 95 with helically winding, and two straight ends 92, 93, also called first end 92 and second end 93. The paper drinking straw 91 might have been cut from an endless paper tube, wherein the endless paper tube has been produced by helically winding of at least one paper layer. The cutting edge 94 of the first end 92 is visible in FIG. 7. The second end 93 also comprises a cutting edge that is not visible in FIG. 7. The paper tube 95 of the paper drinking straw 91 comprises a connection edge 96 where edges of the at least one paper layer firmly adjoin and that extends helically as depicted. The paper tube 95, and thus the paper drinking straw 91 comprise an inner surface 97 pointing to the interior of the paper tube 95/paper drinking straw 91, and an outer surface 98 pointing to the exterior of the paper tube 95/paper drinking straw 91.

For the depicted paper drinking straw, at least one impregnated region of the paper tube 95 may be impregnated with an impregnation agent and at least one region of the paper tube 95 may not be impregnated with the impregnation agent.

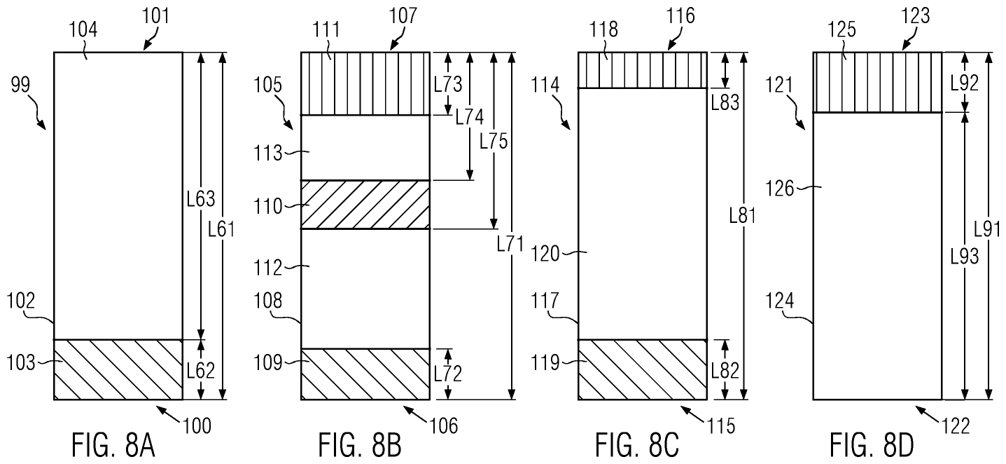

FIGS. 8A, 8B, 8C, 8D illustrate schematically different embodiments of paper drinking straws with two straight first end where different parts are impregnated with an impregnating agent.

In FIG. 8A, the paper drinking straw 99 comprises an impregnated region 103 (“third impregnated region” in the chapter “Solution” and in the claims) starting form the first end 100 of the paper tube 102 and extending towards the second end 101 of the paper tube 102. The paper drinking straw 99 has a total length L61. The impregnated region 103 starts form the first end 100 and extends towards the second end 101 for a first length L62, and is impregnated with the impregnation agent. Along a remaining length L63, the region 104 of the paper tube 102 extends that is not impregnated with the impregnation agent.

In FIG. 8B, the paper drinking straw 105 comprises three impregnated regions 109, 110, 111 that are impregnated with the impregnation agent and two regions 112, 113 that are not impregnated. The paper drinking straw 105 has a total length L71.

The first impregnated region 111 starts from the second end 107 of the paper tube 108 and extends towards the first end 106 of the paper tube 108 for a first length L73 and is impregnated with the impregnation agent.

The second impregnated region 110 starts at a distance L74 from the second end 107 of the paper tube 105 and extends as an annular ring towards the first end 106 of the paper tube 108 and is impregnated with the impregnation agent. The annular ring extends between a distance L74 and a distance L75 form the second end 107 of the paper tube 108.

The third impregnated region 109 starts form the first end 106 of the paper tube 108 and extends towards the second end 107 of the paper tube 108 for a third length L72, and is impregnated with the impregnation agent.

Between the first impregnated region 111 and the second impregnated region 110, a first region 113 extends that is not impregnated with the impregnation agent, and between the second impregnated region 110 and the third impregnated region 109, a second region 112 extends that is not impregnated with the impregnation agent.

In FIG. 8C, the paper drinking straw 114 comprises two impregnated regions 118, 119 that are impregnated with the impregnation agent and one region 120 that is not impregnated. The paper drinking straw 114 has a total length L81.

The first impregnated region 118 starts from the second end 116 of the paper tube 117 and extends towards the first end 115 of the paper tube 117 for a first length L83 and is impregnated with the impregnation agent.

The other impregnated region 119 (“third impregnated region” in the chapter “Solution” and in the claims) starts form the first end 115 of the paper tube 117 and extends towards the second end 116 of the paper tube 117 for a second length L82, and is impregnated with the impregnation agent.

Between the two impregnated regions 118, 119, the one region 120 extends that is not impregnated with the impregnation agent.

In FIG. 8D, the paper drinking straw 121 with a total length L91 comprises an impregnated region 125 (“first impregnated region” in the chapter “Solution” and in the claims) starting from the second end 123 of the paper tube 124 and extending towards the first end 122 of the paper tube 124 for a first length L92 and being impregnated with the impregnation agent. Along a remaining length L93 towards the first end 122, the region 126 of the paper tube 124 extends that is not impregnated with the impregnation agent.

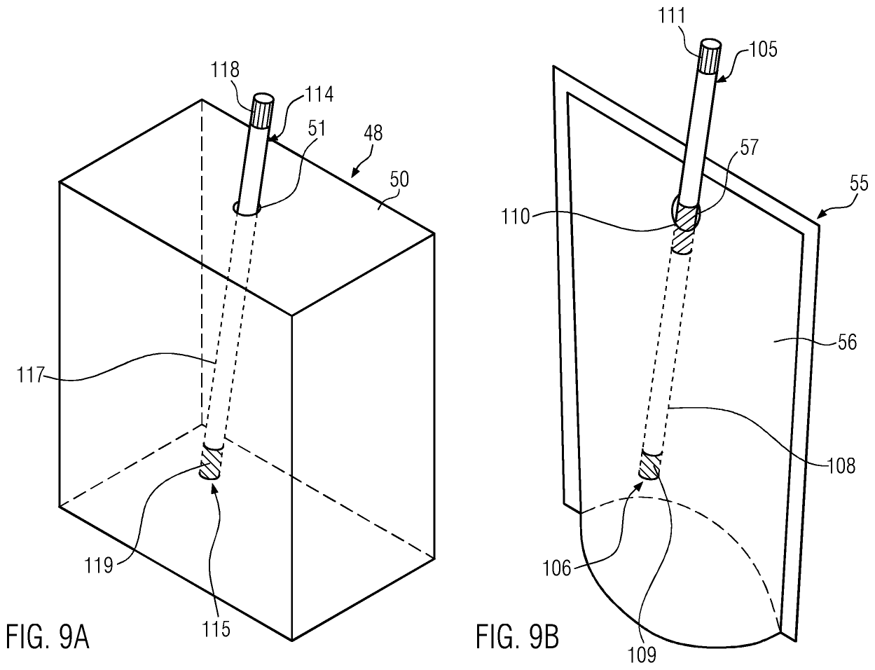

FIG. 9A illustrates an inclined view from above on the beverage carton 48 with the inserted paper drinking straw 114 of FIG. 8C comprising to two straight ends 115, 116, and the two impregnated regions 118, 119 as mentioned above.

FIG. 9B illustrates an inclined view from above on the foil bag 55 with the inserted paper drinking straw 105 of FIG. 8B comprising to two straight ends 106, 107, and the three impregnated regions 109, 110, 111 as mentioned above.

1. A paper drinking straw comprising a paper tube with a first end and a second end and comprising a total length, wherein at least one impregnated region of the paper tube is impregnated with an impregnation agent and at least one region of the paper tube is not impregnated with the impregnation agent.

2. The paper drinking straw of claim 1, wherein the impregnation agent penetrates into pores and spaces between fibers of the paper.

3. The paper drinking straw of claim 1, wherein the at least one impregnated region comprises a first impregnated region starting from the second end of the paper tube and extending towards the first end of the paper tube and being impregnated with the impregnation agent, wherein the first impregnated region extends for less than about 90% of a total length of the paper tube.

4. The paper drinking straw of claim 3, wherein:
(a) the at least one impregnated region comprises a second impregnated region starting at a distance from the second end of the paper tube and extending as an annular ring towards the first end of the paper tube and being impregnated with the impregnation agent,
(b) the annular ring has a width of 10% to 25% of a total length of the paper tube, and
(c) the distance is 20% to 50% of the total length of the paper tube.

5. The paper drinking straw of claim 4, wherein the at least one impregnated region comprises a third impregnated region starting from the first end of the paper tube and extending towards the second end of the paper tube and being impregnated with the impregnation agent, wherein the third impregnated region extends for less than about 90% of the total length of the paper tube.

6. The paper drinking straw of claim 5, wherein when starting from the second end of the paper tube 100% of the total length of the paper tube is not impregnated with the impregnation agent, and a cutting edge at the first end of the paper tube is impregnated with the impregnation agent.

7. The paper drinking straw of claim 4, wherein the impregnation agent comprises silicate, polymer, resin, wax, adhesive, latex, or a mixture thereof.

8. The paper drinking straw of claim 4, wherein the impregnation agent comprises sodium silicate, wherein the molar ratio of SiO₂:Na₂O in sodium silicate is from about 3.3 to about 3.5.

9. The paper drinking straw of claim 7, wherein the paper tube comprises a winded paper layer and wherein the impregnation agent is only applied to exposed surface of the paper tube.

10. The paper straw of claim 9, wherein the paper tube comprises at least one paper layer.

11. The paper straw of claim 8, wherein the first end of the paper tube comprises a straight end and wherein the second end of the paper tube comprises a straight end.

12. The paper straw of claim 8, wherein the first end of the paper tube comprises a beveled tip.

13. The paper drinking straw of claim 12, wherein the beveled tip is at least partially impregnated with the impregnation agent.

14. The paper drinking straw of claim 12, wherein at least an inner surface, an outer surface, or a cutting edge of the beveled tip are impregnated with the impregnation agent.

15. The paper drinking straw of claim 12, wherein regions aside of the beveled tip are not impregnated with the impregnation agent.

16. The paper drinking straw of claim 15, wherein the beveled tip is at least partially impregnated with the impregnation agent only after providing the beveled.

17. A beverage container for receiving liquid product, wherein the beverage container comprises a penetration opening for introducing the paper drinking straw of claim 1, and the paper drinking straw.

18. The beverage container of claim 17, wherein the beverage container is designed as a beverage carton, a foil bag, or as a stand-up pouch.

19. A method for producing a paper drinking straw according to claim 1, the method comprising the consecutive steps of:
(a) providing a raw paper tube;
(b) cutting through the raw paper tube, thereby producing the paper tube; and
(c) impregnating the at least one impregnated region with the impregnation agent and not impregnating the at least one region of the paper tube with the impregnation agent.

20. The method of claim 19, wherein the impregnating the at least one impregnated region comprises at least one of the following characteristics:
(a) impregnating a first impregnated region starting from the second end of the paper tube and extending towards the first end of the paper tube with the impregnation agent, wherein the first impregnated region extends for less than 90% of a total length of the paper tube,
(b) impregnating a second impregnated region starting at a distance from a second end of the paper tube and extending as an annular ring towards the first end of the paper tube with the impregnation agent, wherein the annular ring has a width of 10% to 25% of the total length of the paper tube, wherein the distance is 20% to 50% of the total length of the paper tube, and
(c) impregnating a third impregnated region starting from the first end of the paper tube and extending towards the second end of the paper tube with the impregnation agent, wherein the third impregnated region extends for less than 90% of the total length of the paper tube.

21. The method of claim 19, wherein the impregnating the at least one impregnated region comprises impregnating a cutting edge at the first end of the paper tube with the impregnation agent.

22. The method of claim 19, wherein the cutting through is a straight cutting resulting in a straight first end.

23. The method of claim 19, wherein the cutting through is an oblique cutting resulting in a beveled tip, wherein the method comprises:
(a) at least partially impregnating the beveled tip with the impregnation agent,
(b) impregnating at least an inner surface, an outer surface, or a cutting edge of the beveled with the impregnation agent,
(c) not impregnating regions aside of the beveled tip with the impregnation agent, and
(d) impregnating the beveled tip at least partially with the impregnation agent only after providing the beveled tip.

24. The method according to claim 23, wherein the cutting is done with a cutting knife, wherein the impregnation agent is applied to the cutting knife and wherein the impregnation agent is transferred to the cutting edge during the cutting of the raw paper straw.

25. The method according to claim 24, further comprising solidifying the impregnation agent by hardening or drying, wherein at least two of the following characteristics (a) solidifying the impregnation agent of the at least partially impregnated beveled tip, (b) solidifying the impregnation agent of the first impregnated region, (c) solidifying the impregnation agent of the second region, and (d) solidifying the impregnation agent of the cutting edge by hardening or drying are performed at the same time or at least two different times.
